(19) United States
(12) Patent Application Publication
(10) Pub. No.: US 2008/0242223 A1
(43) Pub. Date: Oct. 2, 2008

(54) INFORMATION COMMUNICATION SYSTEM AND METHOD

(76) Inventor: Toshiaki YAMADA, Saitama (JP)

Correspondence Address: BIRCH STEWART KOLASCH & BIRCH, PO BOX 747, FALLS CHURCH, VA, 22040-0747, US

(21) Appl. No.: 12/058,416

(22) Filed: Mar. 28, 2008

(30) Foreign Application Priority Data
Mar. 29, 2007 (JP) 2007-087589

(51) Int. Cl. H04H 40/00

(52) U.S. Cl. 455/3.06

(57) ABSTRACT

An information communication system for transmitting position data includes a short range wireless communication system for transmitting the position data between a cellular telephone and a digital still camera. There is a communication subsystem for communication, and for transmitting an enable signal between the cellular telephone and the digital still camera to establish the short range wireless communication in response to operation to instruct retrieval of the position data. The enable signal is transmitted while the short range wireless communication is inactive, and establishes the short range wireless communication. A controller terminates the short range wireless communication after the position data is transmitted through. Preferably, the digital still camera outputs the enable signal and receives the position data. Also, in the communication subsystem, public accessible wireless LAN network is used with the digital still camera, and connected with a mobile communication network by a gateway device.

### BACKGROUND OF THE INVENTION

1. Field of the Invention

The present invention relates to an information communication system and method. More particularly, the present invention relates to an information communication system and method in which required power for use in the communication can be reduced and handling of devices can be simple or easy.

2. Description Related to the Prior Art

An information communication system is a technique in which information is transmitted and received between plural electronic devices, such as a digital still camera and a cellular telephone. Various examples are known for communication of information and suggested in documents.

JP-A 2001-211364 discloses communication in which the digital still camera is connected to the cellular telephone in a wired manner. Position data is obtained by the digital still camera and transmitted to the cellular telephone. The cellular telephone accesses a server, receives request information and information according to the position data, and retrieves information related to a present position.

JP-R 2001-238247 discloses a position detecting system of communicating the position data as information between the cellular telephone, the handy GPS and the digital still camera. In the position detecting system, the cellular telephone detects a position of a base station to which the cellular telephone accesses. The position data of the base station is obtained and wirelessly transmitted to the handy GPS. The position data of the precisely determined present position is detected by the handy GPS according to the position data of the base station, and is transmitted to the digital still camera. An antenna, vertical modulator and wireless communication unit are used for connection with a mobile communication network in a wireless manner.

U.S. Pat. No. 6,751,546 (corresponding to JP-A 2001-358978) suggests an information processing system in which a wireless interface is incorporated in each one of a car navigation device, the cellular telephone and the digital still camera having a GPS (Global Positioning System) function. The position data from the car navigation device or the cellular telephone and the image data from the digital still camera are transmitted by the wireless interface. As one example, a request signal for the position data is transmitted by the wireless interface to the cellular telephone when an image is picked up in the digital still camera by depression of a shutter release button. The cellular telephone responsive to the request signal generates the position data, which the digital still camera receives. The position data is stored in association with image data obtained in the digital still camera.

JP-A 2002-366565 discloses an image transmission system in which a short range wireless communication is used, for example Bluetooth. Image data obtained by the digital still camera is transmitted to the cellular telephone having a GPS function. The position data and image data obtained by the cellular telephone are associated with one another, and transmitted from the cellular telephone to database connected with the Internet.

It is sufficient to establish communication only during transmission of information between the electronic device. However, a first one of the electronic device on the transmitting side according to the known techniques of the above documents requires incessantly to detect a request signal for information from a second one of the electronic device on the receiving side. Thus, a circuit for the information communication must be set in a standby mode. This is a problem in a high running cost of the electronic device, because considerable electric power is required for the standby mode for a radio wave. The problem of requirement of much power is specifically serious in a system where frequency of the transmission is somewhat small according to a situation.

It is conceivable to construct a manually operable device for a user to start up and stop the communication of information. However, a problems rises in that the handling for the communication is complicated as the user is obliged to operate manually.

### SUMMARY OF THE INVENTION

In view of the foregoing problems, an object of the present invention is to provide an information communication system and method in which required power for use in the communication can be reduced and handling of devices can be simple or easy.

In order to achieve the above and other objects and advantages of this invention, an information communication system for transmitting data includes a main communication system for transmitting the data between plural electronic devices. A communication subsystem transmits an enable signal between the plural electronic devices in response to operation to instruct retrieval of the data in an on-line status established constantly or intermittently between the plural electronic devices, the enable signal being transmitted while communication of the main communication system is in an off-line status. A controller establishes an on-line status of the main communication system by startup, and establishes the off-line status of the main communication system to terminate communication after the data is transmitted through the main communication system.

The electronic devices include a first electronic device for receiving the enable signal and outputting the data. A second electronic device outputs the enable signal and receiving the data from the first electronic device.

The communication subsystem is a wireless communication system.

The first electronic device includes a data retriever for retrieving the data to be transmitted, and the second electronic device includes an image pickup unit for retrieving image data.

Furthermore, a timer measures first elapsed time elapsed after establishing communication of the main communication system. The controller terminates communication of the main communication system when the first elapsed time becomes more than a predetermined first threshold value.

The first electronic device includes a first interface unit and a first data communication unit. The second electronic device includes a second interface unit and a second data communication unit. The main communication system includes the first and second data communication units, and the communication subsystem includes the first and second interface units.

A first network is used in the communication subsystem, and the second electronic device is connectable therewith. The controller, when the second electronic device is on-line with the first network, transmits the enable signal in the first network, and immediately after transmission, sets the second electronic device off-line from the first network for saving power.

The main communication system is a short range wireless communication system, the first network is a public accessible wireless LAN network and connected with a mobile communication network by a gateway device, and the first electronic device is connectable with the mobile communication network.

The second electronic device generates the enable signal upon shutter releasing of the image pickup unit.

The communication subsystem includes a speaker and a microphone for transmitting and receiving the enable signal in a sound form.

The enable signal is sound created upon shutter releasing of the image pickup unit.

The enable signal is a sound signal on which the data after OFDM modulation is multiplexed. The communication subsystem includes a modulator for OFDM modulation of the data and for multiplexing the data on the sound signal. A speaker outputs the sound signal. A microphone detects the sound signal. A demodulator demodulates the data from the sound signal.

The microphone operates intermittently, and the speaker outputs the sound signal in a longer period than a period of being inactive of the microphone.

The data of transmission by the data retriever is present position data, and a position data source is accessed by the data retriever, for imparting position data.

The data retriever is started up when the enable signal is transmitted in the communication subsystem, and made inactive after retrieval of the position data.

In one preferred embodiment, the second electronic device includes a position data adder for operating in case of lack of position data associated with the image data, for reading second position data associated with second image data, and for adding position data in association with the image data according to the second position data.

The position data for addition is equal to the second position data, or is position data determined according to the second position data by the position data adder.

In another preferred embodiment, if failure occurs in transmission of the enable signal in the communication subsystem upon retrieval of the image data, the position data adder suppresses addition of the position data.

In one preferred embodiment, if a difference between a date or time of retrieval of the image data and a date or time of retrieval of the second image data is equal to or more than a predetermined threshold value, the position data adder suppresses addition of the position data.

In still another preferred embodiment, if a date of retrieval of the image data is different from a date of retrieval of the second image data, the position data adder suppresses addition of the position data.

Furthermore, data storage stores the image data and the position data associated therewith. When the position data adder adds the position data to the image data, status information is written to the data storage, the status information being associated with the image data for expressing a status of the addition.

In one preferred embodiment, furthermore, a timer measures elapsed time elapsed after retrieval of the position data. If the elapsed time is equal to or less than a predetermined threshold value, the communication subsystem suppresses communication of the enable signal.

In another preferred embodiment, the image pickup unit is operable to pick up consecutive images. The communication subsystem communicates with the enable signal for a first one of the consecutive images, and suppresses communication of the enable signal for second and succeeding images among the consecutive images.

In one aspect of the invention, an information communication method for transmitting data between plural electronic devices is provided, and includes transmitting an enable signal through a communication subsystem between the plural electronic devices in response to operation to instruct retrieval of the data, the enable signal being transmitted while communication of the main communication system is inactive, and establishing communication of a main communication system by verification. The data is transmitted through the main communication system between the plural electronic devices. Communication of the main communication system is terminated after the data is transmitted.

Accordingly, required power for use in the communication can be reduced and handling of devices can be simple or easy, because the communication subsystem starts up the main communication system, and communication of the main communication system is terminated after the data is transmitted.

### BRIEF DESCRIPTION OF THE DRAWINGS

The above objects and advantages of the present invention will become more apparent from the following detailed description when read in connection with the accompanying drawings, in which:

FIG. 1 is an explanatory view schematically illustrating an information communication system of the invention;

FIG. 2 is a block diagram illustrating a digital still camera;

FIG. 3 is a block diagram illustrating a cellular telephone;

FIGS. 4A and 4B are a flow chart illustrating a sequence of operation of the information communication system;

FIG. 5 is an explanatory view illustrating another preferred communication subsystem in which a sound signal is an enable signal;

FIGS. 6A and 6B are a flow chart illustrating a sequence of the communication subsystem;

FIG. 7 is a block diagram illustrating a digital still camera in connection with one preferred communication subsystem in which an enable signal is data after OFDM modulation;

FIG. 8 is a block diagram illustrating a cellular telephone for use with the digital still camera of FIG. 7;

FIG. 9 is a timing chart illustrating a relationship between an operating period of a microphone and a period of outputting sound;

FIG. 10 is a block diagram illustrating one preferred digital still camera having a position data adder;

FIG. 11 is a flow chart illustrating addition of position data with the digital still camera;

FIG. 12 is a flow chart illustrating another adding sequence of position data;

FIG. 13 is a flow chart illustrating a sequence in which position data retrieval is suppressed before lapse of time; and

FIG. 14 is a flow chart illustrating a sequence of a digital still camera in a consecutive image pickup.

### DETAILED DESCRIPTION OF THE PREFERRED EMBODIMENT(S) OF THE PRESENT INVENTION

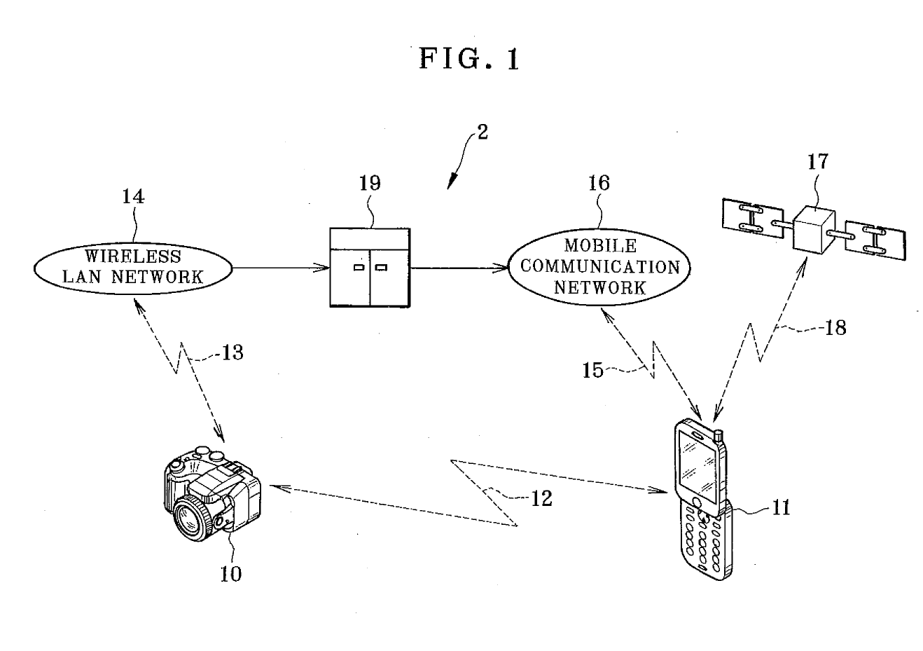

In FIG. 1, an information communication system 2 of the invention includes a digital still camera 10 as electronic device, and a cellular telephone 11 as electronic device. The digital still camera 10 obtains image data but without position data. The cellular telephone 11 has GPS function, obtains position data of a latitude and longitude, and wirelessly transmits the position data to the digital still camera 10. The image data obtained in the digital still camera 10 is stored in association with the position data.

Position data is transmitted from the cellular telephone 11 to the digital still camera 10 with a short range wireless radio wave 12 according to short range wireless communication, for example Bluetooth, IEEE 802.15.1. The digital still camera 10 has a function of wireless LAN, and communicates by use of network radio wave 13 with a public accessible wireless LAN network 14 as first network. The public accessible wireless LAN network 14 is according to IEEE 802.11 series. Access points are installed in public places, for example on the street, and adapted to connection to the wireless LAN network 14.

The cellular telephone 11 wirelessly connects with a mobile communication network 16 as second network. A mobile radio wave 15 is emitted to and from the cellular telephone 11, so radio transmission and reception with a base station (not shown) of the mobile communication network 16 is made for the communication. Also, a GPS satellite 17 as position data source is included in the information communication system 2. A GPS radio wave 18 is transmitted to or received from the GPS satellite 17 with the cellular telephone 11, which can retrieve position data. Note that the retrieval of position data is not limited to the GPS technique. For example, a position data retrieval service such as PHS can be used, in which a base station is utilized.

A gateway device 19 is connected between the wireless LAN network 14 and the mobile communication network 16. The gateway device 19 carries out protocol conversion in a communication path between the wireless LAN network 14 and the mobile communication network 16.

The digital still camera 10 communicates by use of the network radio wave 13 to transmit an enable signal (to be described later). The enable signal from the digital still camera 10 is sent to the gateway device 19 through the wireless LAN network 14, and subjected to protocol conversion. The converted enable signal is sent to the mobile communication network 16, from which the mobile radio wave 15 is transmitted to the cellular telephone 11 as enable signal.

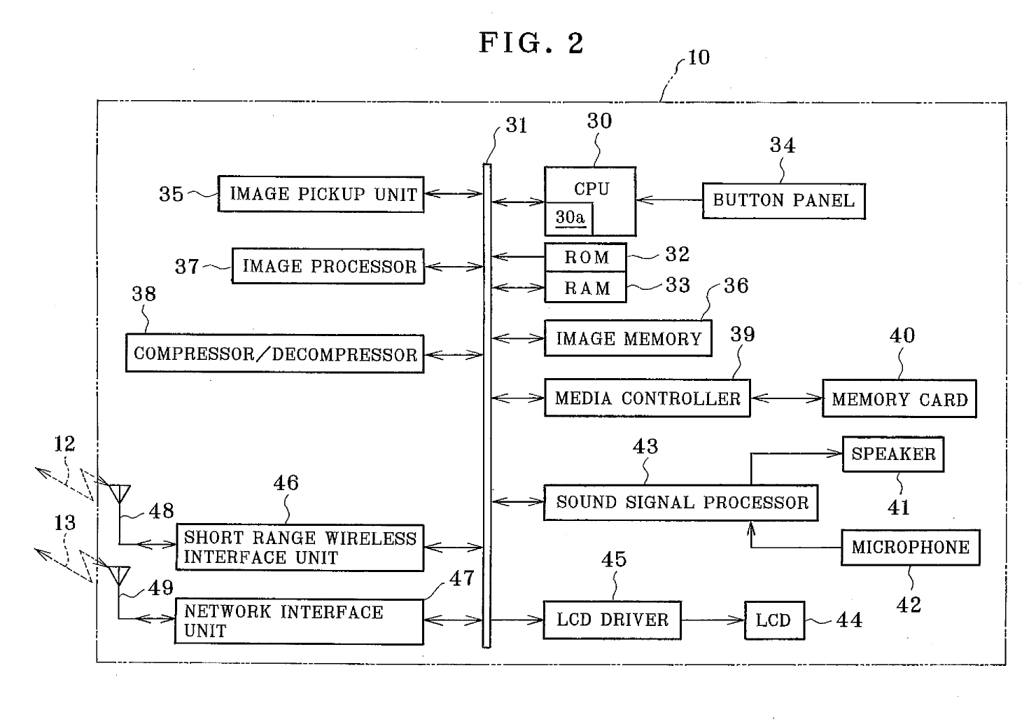

In FIG. 2, circuit elements in the digital still camera 10 are illustrated. A CPU 30 is connected with the various circuit elements by a data bus 31, to control the entirety of the digital still camera 10. A ROM 32 is a memory for storing data and various programs for the digital still camera 10. A RAM 33 or working memory is used by the CPU 30 for processing with programs and data read from the ROM 32. The programs are run one after another.

A button panel 34 or user interface is connected to the CPU 30. The button panel 34 includes a shutter release button for image pickup, and various buttons for setting a shutter speed, aperture stop value, zoom magnification, designated status for retrieval of position data, and the like. The CPU 30 is responsive to instruction signals generated by the button panel 34, and controls various elements according to the signals.

An image pickup unit 35 includes a lens system, a CCD as image pickup device, and an analog signal processor which includes a correlated double sampling circuit (CDS), amplifier, and an A/D converter and the like. An object image is photographed through the lens system. The CCD outputs an image signal by photoelectric conversion of the object image. The image signal is subjected to correlated double sampling, amplification, A/D conversion and the like, so that image data of a digital form is generated. An image memory 36 as data storage stores the image data created by the image pickup unit 35.

An image processor 37 reads image data from the image memory 36, subjects the image data to image processing of various settings including gradation conversion, white balance correction, gamma correction and the like. Then the image processor 37 stores converted image data in the image memory 36. The image data is read from the image memory 36 by a Y/C separator (not shown), which generates luminance signal Y and chrominance signal Cr and Cb.

A compressor/decompressor 38 compresses the image data after the Y/C separation in a predetermined format of the compression, for example JPEG format. A memory card 40 as data storage is caused to store the compressed image data by a media controller 39. Image data in the memory card 40 is then written to the image memory 36 in a temporary manner by the media controller 39, and is read by the compressor/decompressor 38, which creates image data before the compression.

A speaker 41 emits various kinds of sound, for example a shutter release sound upon the depression of the shutter release button. Data for sound of various operations are stored in the ROM 32. A sound signal processor 43 is supplied by data read from the ROM 32 by the CPU 30. A microphone 42 detects ambient sound in the peripheral space in pickup of a motion picture.

The sound signal processor 43 is connected with the speaker 41 and the microphone 42. The sound signal processor 43 converts sound data generated by the CPU 30 in the D/A conversion, and outputs the sound data to the speaker 41. Also, the sound signal processor 43 converts sound detected by the microphone 42 in the A/D conversion to obtain a digital sound signal, which is input to the CPU 30. The sound signal is stored in the memory card 40 in association with the image data obtained by motion image pickup.

There is an LCD driver 45. An LCD display panel 44 is controlled by the LCD driver 45, and displays a live image of the image data after conversion in the Y/C separator, and also displays an image of image data decompressed by the compressor/decompressor 38.

There are a short range wireless interface unit 46 as data communication unit in a main communication system, and a network interface unit 47 in the public accessible wireless LAN network 14 in a communication subsystem or call subsystem. Each of those is constituted by known wireless circuits, for example, modulator, demodulator, amplifier, band-pass filter and the like. A short range wireless antenna 48 is connected by wiring with the short range wireless interface unit 46 for communication with the short range wireless radio wave 12. A network antenna 49 is connected by wiring with the network interface unit 47 for communication with the network radio wave 13.

The short range wireless interface unit 46 is normally inactive. When an image is picked up by depression of the shutter release button to generate an enable signal, the short range wireless interface unit 46 is started up. Note that the short range wireless interface unit 46 does not start up even upon depression of the shutter release button if the status of retrieval of the position data is not set at the button panel 34.

The short range wireless interface unit 46 when started up outputs a communication request signal for communication with the cellular telephone 11. Also, the short range wireless interface unit 46 outputs a data request signal for request of position data while on-line with the cellular telephone 11.

The short range wireless interface unit 46 outputs a termination signal for terminating communication with the cellular telephone 11 upon a lapse of a predetermined time after establishing communication with the cellular telephone 11. The short range wireless interface unit 46 becomes inactive upon termination from the cellular telephone 11. Predetermined time of lapse before outputting a termination signal is set with a sufficient length for receiving position data from the cellular telephone 11 after transmitting a data request signal to the cellular telephone 11. An internal clock circuit 30a or timer is incorporated in the CPU 30. Time of lapse from the establishment of communication with the cellular telephone 11 is measured by the output from the clock circuit 30a.

The short range wireless interface unit 46 demodulates the short range wireless radio wave 12 from the cellular telephone 11 to obtain the initial position data, which is input to the CPU 30. The CPU 30 controls the media controller 39 to write the position data to the memory card 40 in association with image data.

The network interface unit 47 normally operates in a low power mode. When a shutter release button is depressed for image pickup, the network interface unit 47 comes to stand by for receiving the network radio wave 13. An enable signal is output by the network interface unit 47 while on-line with the wireless LAN network 14 upon reception of the network radio wave 13.

The enable signal includes signal components, which are call information for identifying the cellular telephone 11, for example telephone number of the cellular telephone 11, and control command signals for startup of a short range wireless interface unit 69 as data communication unit in a main communication system, and a GPS interface unit 71. The network interface unit 47, after outputting the enable signal, is set in the low power mode again.

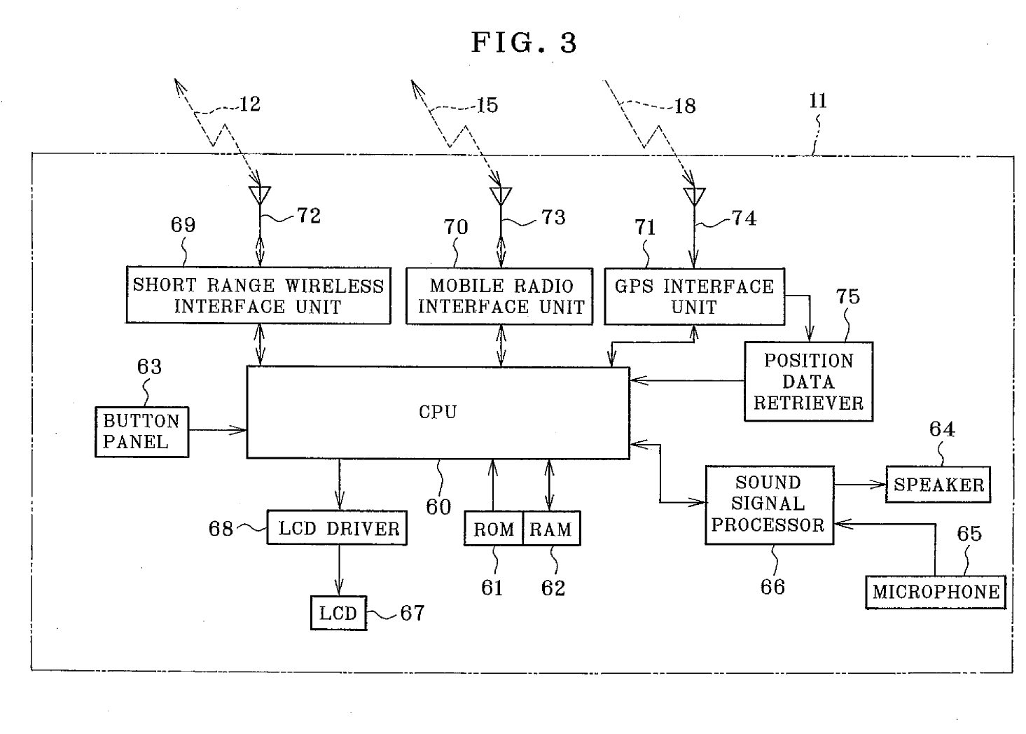

In FIG. 3, circuit elements of the cellular telephone 11 are illustrated. A CPU 60 controls the entirety of the cellular telephone 11. A ROM 61 stores programs and data for operating the cellular telephone 11. A RAM 62 or working memory is used by the CPU 60 for processing with programs and data read from the ROM 61. The programs are run one after another.

A button panel 63 or user interface is disposed on the CPU 60. The button panel 63 includes a call button, power/stop button, key wheel, cross-shaped key and the like. The CPU 60 responds to instruction signals from the button panel 63, and causes various elements to operate according to the signals.

A speaker 64 emits sound or voice of a user in a telephone call. A microphone 65 as sound detector detects sound or voice in the telephone call. A sound signal processor 66 is connected with the speaker 64 and the microphone 65. A mobile radio interface unit 70 in a communication subsystem or call subsystem demodulates the digital sound signal from the CPU 60. The sound signal processor 66 converts the digital sound signal by D/A conversion, and causes the speaker 64 to emit sound. Also, the sound signal processor 66 receives sound detected by the microphone 65, and converts the sound by A/D conversion, to input a sound signal to the CPU 60. An LCD display panel 67 is controlled by an LCD driver 68, and displays various menus or screens for operation and settings.

The short range wireless interface unit 69 communicates by use of the short range wireless radio wave 12. The mobile radio interface unit 70 communicates by use of the mobile radio wave 15. The GPS interface unit 71 communicates by use of the GPS radio wave 18. Each of those interface units is constituted by known wireless communication circuit in a manner similar to the short range wireless interface unit 46 and the network interface unit 47. A short range wireless antenna 72 is connected by wiring with the short range wireless interface unit 69 in the main communication system for the short range wireless radio wave 12. A telephone antenna 73 is connected by wiring with the mobile radio interface unit 70 for the mobile radio wave 15. A GPS antenna 74 is connected by wiring with the GPS interface unit 71 for the GPS radio wave 18.

The short range wireless interface unit 69 is normally inactive similarly to the short range wireless interface unit 46, and is started up in response to an enable signal from the digital still camera 10. Thus, the digital still camera 10 initially calls the cellular telephone 11. The short range wireless interface unit 69, when the digital still camera 10 emits a request signal, responsively outputs an allowance signal to allow communication with the digital still camera 10. Also, the short range wireless interface unit 69, when the digital still camera 10 emits a termination signal, responsively terminates communication with the digital still camera 10, and becomes inactive.

A position data retriever 75 detects position data of a position. The short range wireless interface unit 69 modulates the position data input to the CPU 60. The short range wireless radio wave 12 is created by the short range wireless interface unit 69 and emitted by the short range wireless antenna 72.

The mobile radio interface unit 70 is always active, and communicates with a base station by use of the mobile radio wave 15. The mobile radio interface unit 70 modulates signals into the mobile radio wave 15, the signals including a request signal for a call with other telephones, and a sound signal from the sound signal processor 66. Also, the mobile radio interface unit 70 demodulates the mobile radio wave 15 from the base station into signals such as a request signal, sound signal and enable signal. The signals after the demodulation are input to the CPU 60.

The position data retriever 75 is connected by wiring with the GPS interface unit 71. The GPS interface unit 71 and the position data retriever 75 are normally inactive, and become started up upon receipt of an enable signal from the digital still camera 10. According to the GPS radio wave 18, the position data retriever 75 measures latitude and longitude (and height) of the present position of the cellular telephone 11, and outputs position data to the CPU 60 as a result of the measurement. The GPS interface unit 71 and the position data retriever 75, after retrieval of the position data, are rendered inactive.

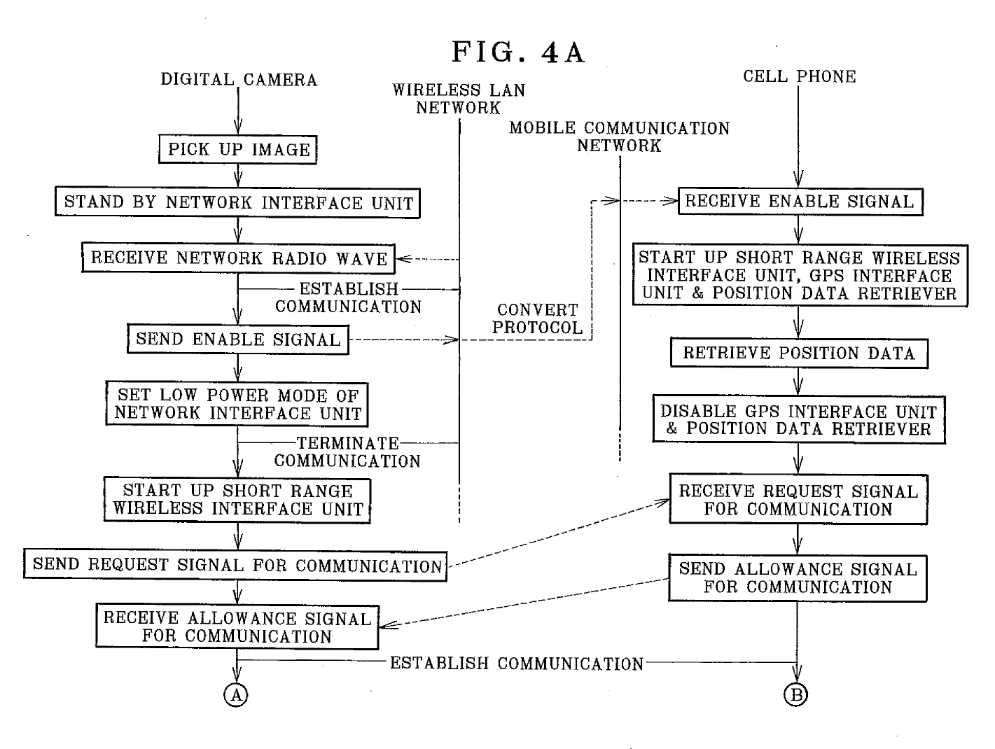

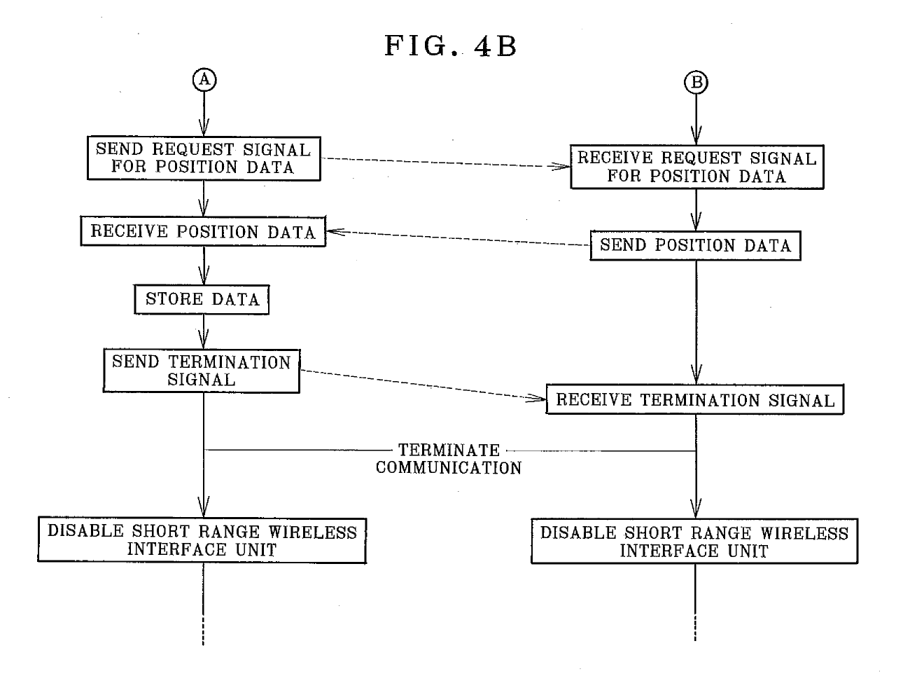

The operation of the information communication system 2 of the above construction is described with reference to a flow of FIGS. 4A and 4B. Note that components in the information communication system 2 are safely active and connectable. Power sources for the digital still camera 10 and the cellular telephone 11 are turned on. The digital still camera 10 is located in a reception range of the network radio wave 13. The cellular telephone 11 is located in a reception range of the mobile radio wave 15. The digital still camera 10 and the cellular telephone 11 are positioned within a communication range of the short range wireless radio wave 12.

At first, the shutter release button of the digital still camera 10 is depressed to pickup an image. The network interface unit 47 in the low power mode is set in a communication standby mode for communication with the network radio wave 13. When the network radio wave 13 is received by the network antenna 49, communication between the digital still camera 10 and the wireless LAN network 14 is established, to exchange data on-line.

In the state on-line with the wireless LAN network 14, an enable signal is output by the network interface unit 47, and transmitted by the network antenna 49. The enable signal from the network antenna 49 is passed in the wireless LAN network 14, and becomes converted for protocol conversion by the gateway device 19.

The enable signal after the protocol conversion in the gateway device 19 is transmitted to the mobile communication network 16. Transmission between the mobile communication network 16 and the cellular telephone 11 having a telephone number designated by the enable signal is started according to the line switching system. The enable signal is sent to the cellular telephone 11. Note that it is possible to use a packet communication system to carry out paging of the cellular telephone 11 and to send the enable signal.

Upon reception of the enable signal with the telephone antenna 73, the call of the digital still camera 10 is initially accepted by the cellular telephone 11. The short range wireless interface unit 69, the GPS interface unit 71 and the position data retriever 75 are started up in the cellular telephone 11. The position data retriever 75 with the GPS interface unit 71 retrieves the position data. The position data is input to the CPU 60. After the retrieval, the GPS interface unit 71 and the position data retriever 75 are made inactive.

After transmission of the enable signal, the network interface unit 47 in the digital still camera 10 is set again in the low power mode, to terminate communication with the wireless LAN network 14. The short range wireless interface unit 46 is started up. A request signal is output by the short range wireless interface unit 46, and transmitted by use of the short range wireless antenna 48.

The cellular telephone 11 stands by in a standby state for a request signal, as the short range wireless interface unit 69 is started up with the enable signal. When the request signal is received by the short range wireless antenna 72, then the digital still camera 10 is subjected for verification of checking whether the digital still camera 10 with the request signal is the same as that which has transmitted the enable signal. After the verification, the short range wireless interface unit 69 outputs an allowance signal, which is wirelessly output by the short range wireless antenna 72.

When the allowance signal is received by the short range wireless antenna 48, communication between the digital still camera 10 and the cellular telephone 11 is established, to permit transmission of data between those. Measurement of time is started from the establishment of the communication according to an output of the clock circuit 30a.

After establishing communication with the cellular telephone 11, the short range wireless interface unit 46 outputs a data request signal, which is wirelessly transmitted by the short range wireless antenna 48. Upon reception of the data request signal, the position data is output by the CPU 60 to the short range wireless interface unit 69, and is wirelessly transmitted by the short range wireless antenna 72.

When the position data is received by the short range wireless antenna 48, the position data in association with the image data is written to the memory card 40 in the digital still camera 10 in a controlled state of the media controller 39.

When a predetermined time elapses after establishing communication with the cellular telephone 11, a termination signal is output by the short range wireless interface unit 46, and wirelessly transmitted by the short range wireless antenna 48. After this, the short range wireless interface unit 46 is made inactive. When the short range wireless antenna 72 in the cellular telephone 11 receives the termination signal, the short range wireless interface unit 69 is made inactive. This is a sequence which will be repeated in steps of image pickup of succeeding images.

In short, the short range wireless interface units 46 and 69, the GPS interface unit 71 and the position data retriever 75 are started up only for the time of retrieval of position data by use of the enable signal from the digital still camera 10 to the cellular telephone 11 via the wireless LAN network 14 and the mobile communication network 16. This is effective in easily obtaining position data without complicated operation of a user. Also, power for use in the operation can be low in comparison with a structure in which those circuits would operate constantly without break. The use of the mobile communication network 16 always in connection with the cellular telephone 11 is advantageous in the simple construction for communication.

In the above description, the network radio wave 13, the mobile radio wave 15, and the short range wireless radio wave 12 are safely transmitted by suitable positioning of the digital still camera 10 and the cellular telephone 11. However, failure is likely to occur according to unexpected states of radio waves and operation. Examples of failing states include failure in reception of the network radio wave 13 for connection with the wireless LAN network 14, failure in transmission of an enable signal from the mobile communication network 16 for startup of the short range wireless interface unit 69, and failure in reception of a request signal at the cellular telephone 11 for established communication of the digital still camera 10.

In the case of failure of such types, transmission and reception of the signal for establishing communication are attempted for plural times. Even after this, the failure is likely to remain without solution. Then retrieval of the position data is interrupted as unsuccessful. There is only a step of making inactive the short range wireless interface units 46 and 69, the GPS interface unit 71 and the position data retriever 75.

In the above embodiment, predetermined time elapses after establishing communication between the digital still camera 10 and the cellular telephone 11 and before making inactive the short range wireless interface units 46 and 69. However, it is possible to generate a termination signal immediately after the retrieval of the position data to make the short range wireless interface units 46 and 69 inactive. When the power source for a selected one of the digital still camera 10 and the cellular telephone 11 is turned off, the selected device turned off generates a termination signal to make inactive the short range wireless interface units 46 and 69. Furthermore, it is possible to use a clock circuit in the CPU 60 of the cellular telephone 11 to measure time in place of the clock circuit 30a of the digital still camera 10.

Note that the network interface unit 47 may constantly stand by for reception of the network radio wave 13. Also, the short range wireless interface unit 46 may be started up at the same time as the return of the network interface unit 47 to the standby state. Furthermore, position data can be retrieved after establishing communication between the digital still camera 10 and the cellular telephone 11. It is possible to modify the sequence of the steps in the above embodiment within the scope of the invention.

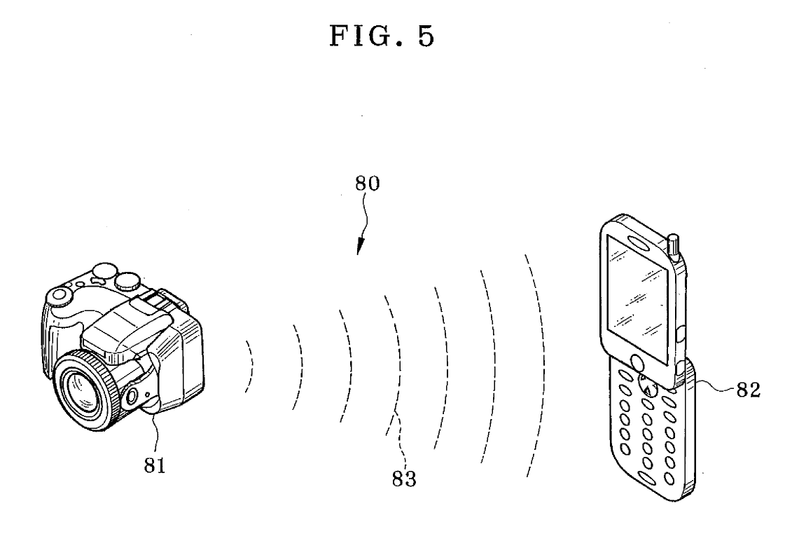

In FIG. 5, another preferred information communication system 80 of the invention is illustrated. An enable signal from a digital still camera 81 to a cellular telephone 82 is a sound signal. A sound 83 is emitted by the digital still camera 81 with a frequency characteristic at a constant volume, and is detected by the cellular telephone 82. Elements similar to those of the embodiment of FIGS. 2 and 3 are designated with identical reference numerals, as the digital still camera 81 is structurally the same as the digital still camera 10 except for the network interface unit 47 and the network antenna 49.

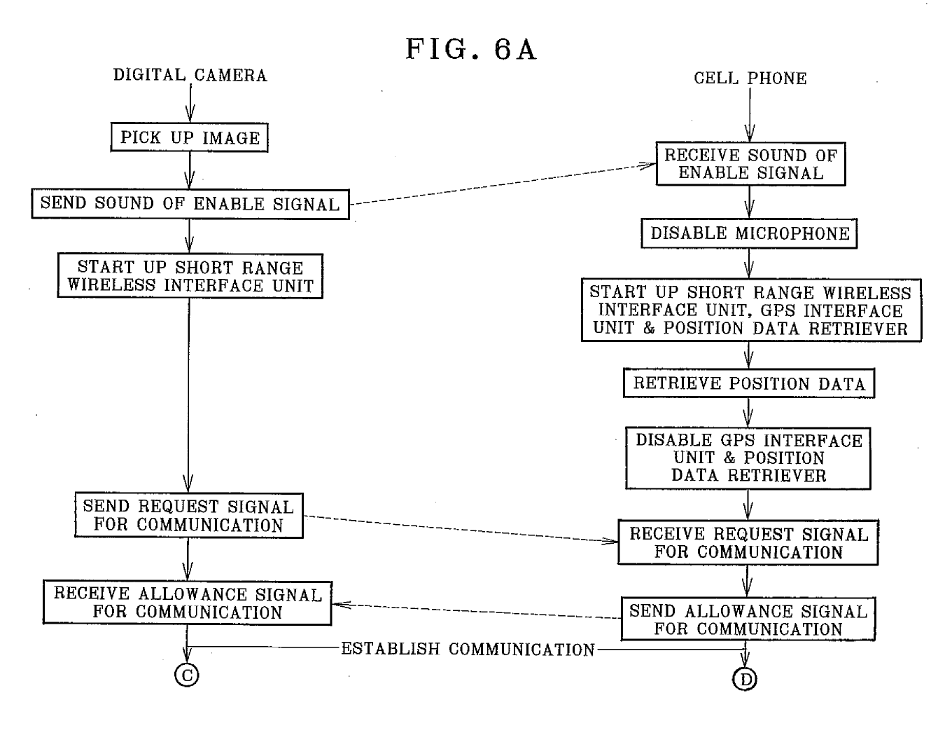

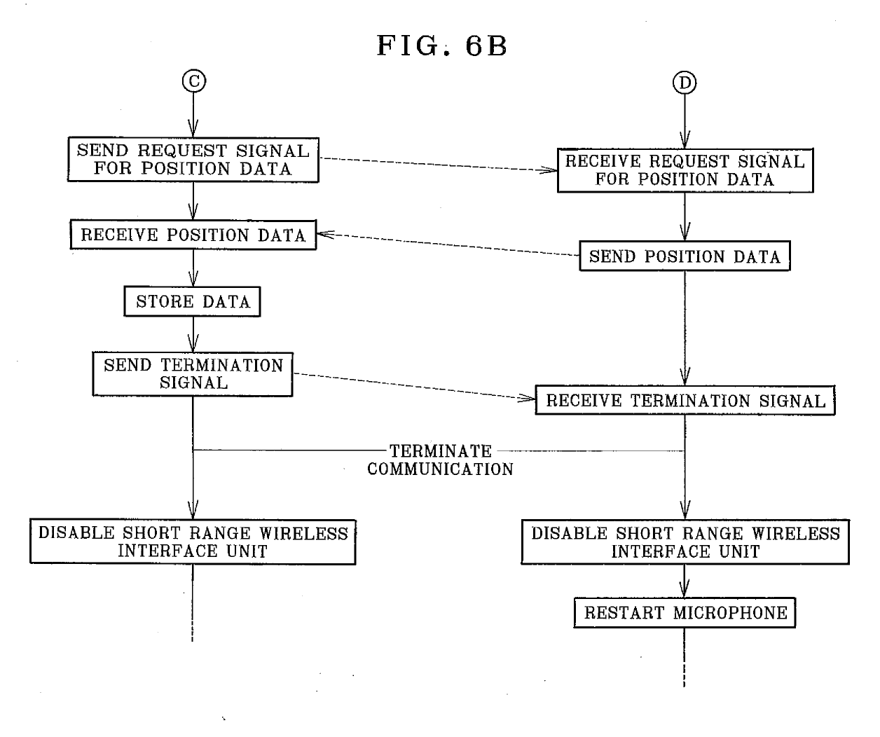

Data of frequency characteristic of the sound 83 is previously stored in the ROMs 32 and 61. In FIGS. 6A and 6B, the sound 83 is stored in the ROM 32 and read by the CPU 30 upon the depression of the shutter release button of the digital still camera 81. The sound 83 is output by the speaker 41 after processing in the sound signal processor 43. The sound 83 is detected by the microphone 65 in the cellular telephone 82, converted into a sound signal of a digital form by the sound signal processor 66, and output to the CPU 60.

Then the CPU 60 checks whether or not the sound signal is a signal of the sound 83 having the frequency characteristic stored in the ROM 61. If it is, then the short range wireless interface unit 69, the GPS interface unit 71 and the position data retriever 75 are started up in the manner similar to the above embodiment. Note that the microphone 65 is kept inactive during transmission of the position data by use of the short range wireless interface unit 69, the GPS interface unit 71 and the position data retriever 75, so there is no detection of the sound 83. When the transmission of the position data is completed, the communication is terminated. Then the microphone 65 is made active again to restart detecting the sound 83.

As a communication subsystem, the enable signal is transmitted and received by the combination of the speaker 41 of the digital still camera 81 and the microphone 65 of the cellular telephone 82. This is effective in reducing the manufacturing cost in comparison with the first preferred embodiment in which a communication device for use with the wireless LAN network 14 is included.

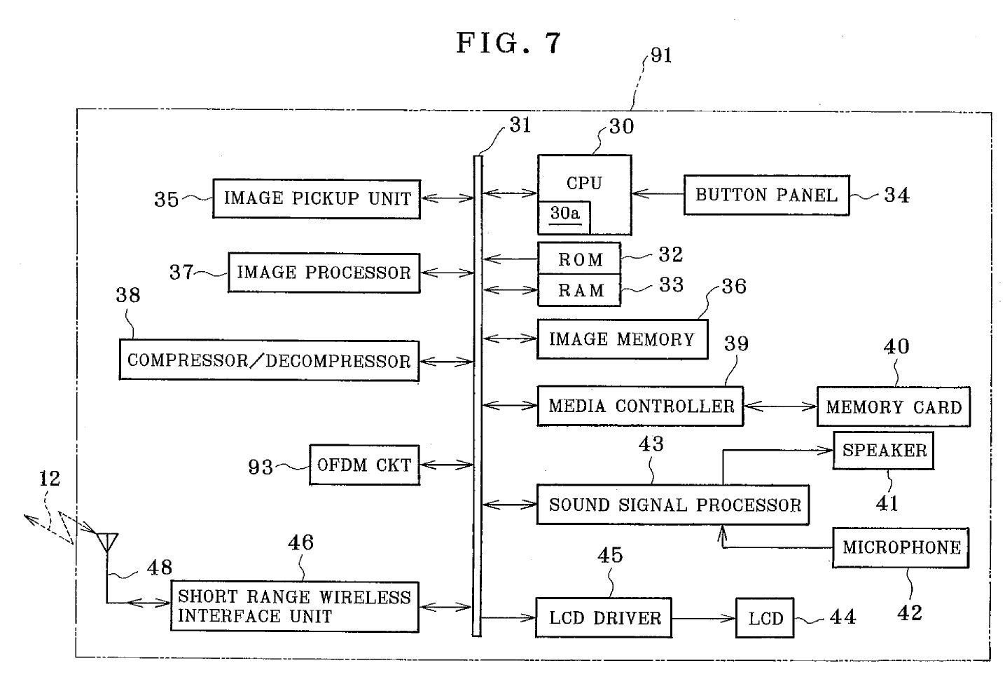

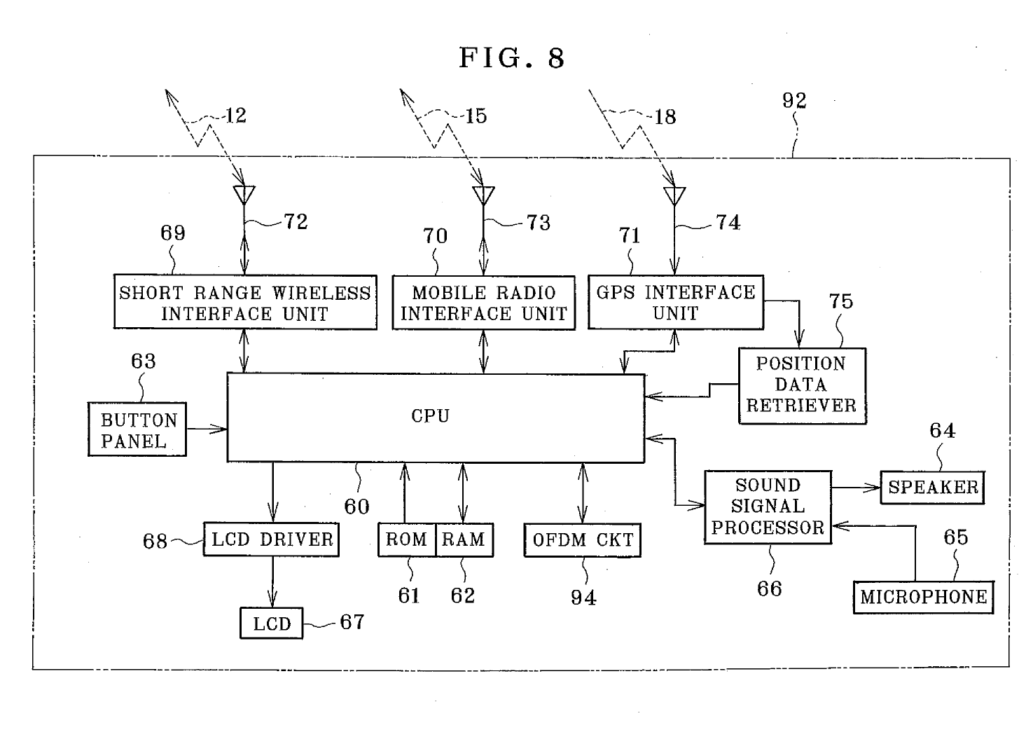

Still another preferred information communication system is described. An enable signal from a digital still camera 91 to a cellular telephone 92 is a signal component which is constituted by text data and bit data as enable signal component. The text data and bit data are multiplexed with a sound signal, which is acoustically transmitted from the digital still camera 91 to the cellular telephone 92. In FIG. 7, an OFDM (orthogonal frequency division multiplexing) circuit 93 for modulation is incorporated in the digital still camera 91. In FIG. 8, an OFDM circuit 94 for demodulation is incorporated in the cellular telephone 92. The digital still camera 91 is structurally the same as the digital still camera 10 of FIG. 2 except for the network interface unit 47 and the network antenna 49 and addition of the OFDM circuit 93.

The OFDM circuit 93 extracts a low frequency component from a sound with a predetermined frequency characteristic (for example, the sound 83 of the above embodiment) by cutting a high frequency component. In the band of the high frequency component being cut, text data and bit data representing the enable signal is subjected to OFDM modulation, to generate sub carriers. Intensity of the sub carriers created by the modulation is adjusted to be equal to intensity of a high frequency component being cut. Finally, the sub carriers with adjusted intensity combined with the low frequency component extracted initially. Therefore, a sound signal is created with multiplexed text data and bit data for the enable data. To human ears, there is no difference between the sound signal and natural sound without multiplexing.

The OFDM circuit 94 demodulates the text data and bit data expressing the enable data from the sound signal in a sequence reverse to the OFOM circuit 93. Specifically, the OFDM circuit 94 derives the high frequency component from the sound signal, and separates the sub carriers multiplexed with the high frequency component for the initial intensity before the adjustment. The separated sub carriers are demodulated by OFDM demodulation to obtain the initial text data and bit data. For a flow of the present embodiment, the flow of the above embodiment is repeated with a difference of only the OFDM circuits 93 and 94.

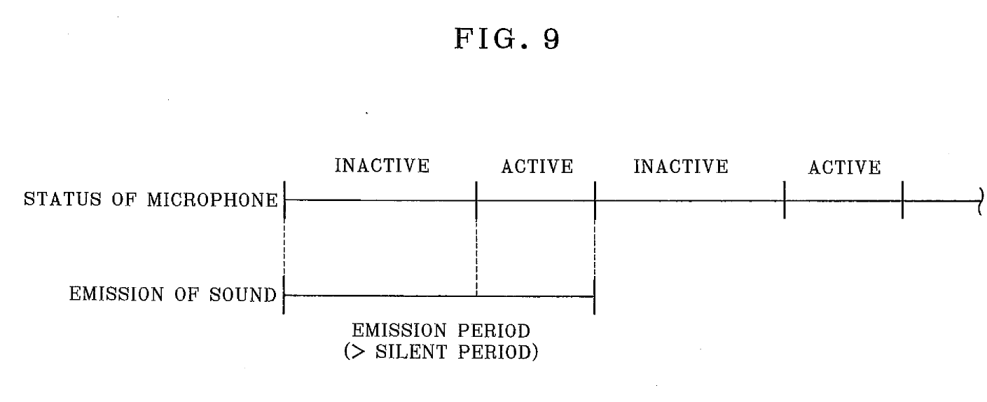

In the second and third preferred embodiment, it is unnecessary to operate the microphone 65 constantly. See FIG. 9. The microphone 65 can operate intermittently with an interval for stop. It is preferable to set a longer period of emitting sound than a period of the stop in the interval of the operation, so as to record sound in the operation period of the microphone 65 without fail. Power used for operating the microphone 65 can be small. This is effective in promoting saving of power.

Note that an example of sound can be a sound of the shutter release emitted upon depression of the shutter release button. In addition, a beep sound can be previously prepared and stored in a distinct manner from the shutter release sound. The camera can emit the beep sound and then the shutter release sound. Other examples of the emission sound may be a sound prepared originally by a user, a sound recorded by the camera at the time of motion image pickup, and the like. It is possible to determine a difference of the camera from other cameras, to facilitate the verification for the purpose of establishing the short range wireless communication.

Furthermore, other preferred embodiment can be conceived in addition to the first, second and third preferred embodiments. When the power source of the camera and the telephone is turned on, the short range wireless interface units 46 and 69 are started up to establish the short range wireless communication, and are kept in the standby state. When the shutter release button is depressed for image pickup, a data request signal is transmitted and received. The GPS interface unit 71 and the position data retriever 75 are started up to retrieve position data, which is transmitted and received. After the communication of the position data, the short range wireless interface units 46 and 69 are set in the standby state again. Note that a shutter release button can have a two step structure for the steps of focusing and image pickup. In the data retrieval, the shutter release button may be depressed halfway in the first step to transmit a data request signal, and depressed deeply in the second step to receive transmitted position data.

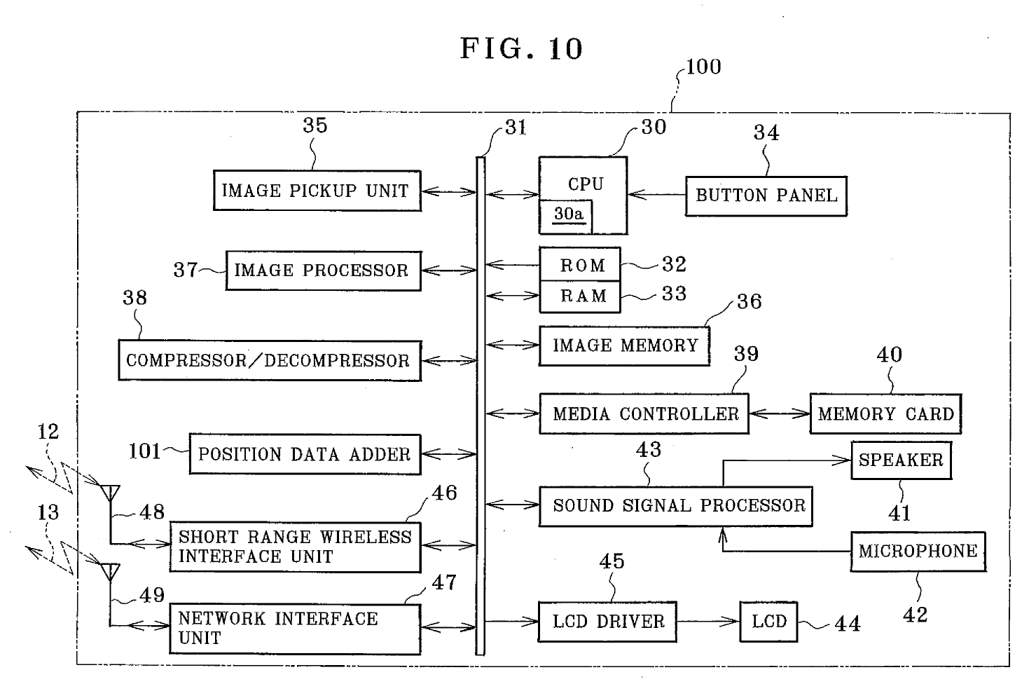

Failure is likely to occur in the retrieval of position data, for such reasons as disorder in the wireless communication, and failure in sound detection with disorder of the speaker 41 or the microphone 65. A digital still camera 100 as electronic device of FIG. 10 is constructed to solve this problem. A position data adder 101 is incorporated in the digital still camera 100, and operates to add position data to first image data N of an image for which no position data is associated. For the digital still camera 100, the digital still camera 10 of the FIG. 2 is repeated with the difference of the position data adder 101.

The position data adder 101 is supplied with second image data Y other than the first image data N, and create position data for addition to the image data N according to the position data associated with the second image data. Note that meta information is recorded and stored in association with the image data, including a date or time of the image pickup, designated status of retrieval of position data and the like.

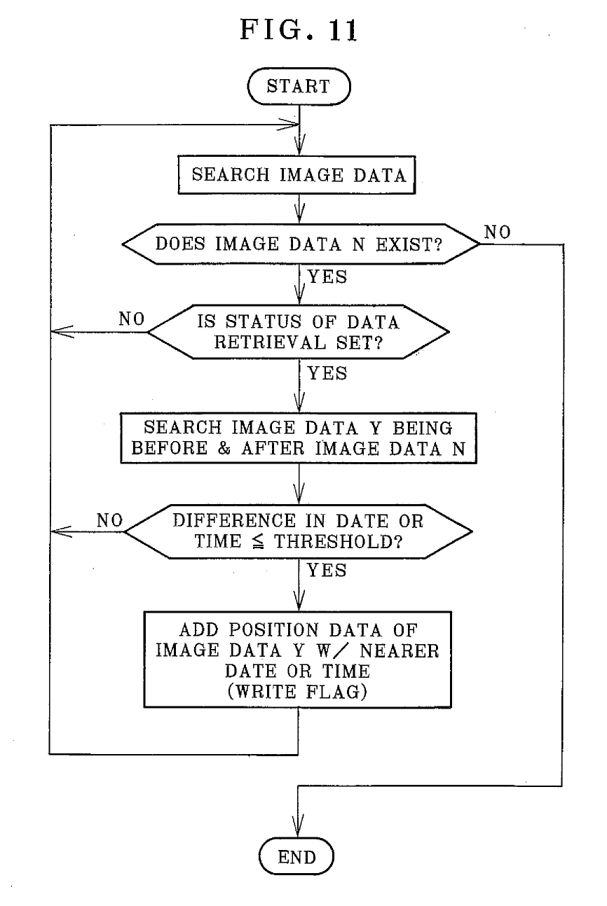

A flow chart of FIG. 11 is referred to now. At first, the first image data N is searched among image data stored in the memory card 40. It is checked whether the designated status of retrieval of position data was set by the button panel 34 when the first image data N was recorded. If it is found that the designated status for the first image data N is no retrieval of position data, then the routine returns.

The case of the designated status of retrieval of position data is described now. Second image data Y of two images are searched and read from the memory card 40 with a date or time directly before and after a date or time of the first image data N. Then a difference between the date or time of the second image data Y and the date or time of the first image data N is obtained by subtraction, and compared with a threshold value. If the difference is equal to or more than the threshold value, then a rejection flag is generated and associated with the first image data N to return the routine, because the second image data Y are supposedly obtained by image pickup in a place different from that of the first image data Y.

If the difference is less than the threshold value, then the position data associated with the image data Y of one of the two images with a nearer date or time is added to image data N as new position data. Also, a flag as status information is associated with the image data N as meta information of the addition of the position data. Then the routine returns. This sequence is repeated until all of the image data in the memory card 40 are treated. Note that the threshold value may be adjustable, and can be set manually by a user operating the button panel 34.

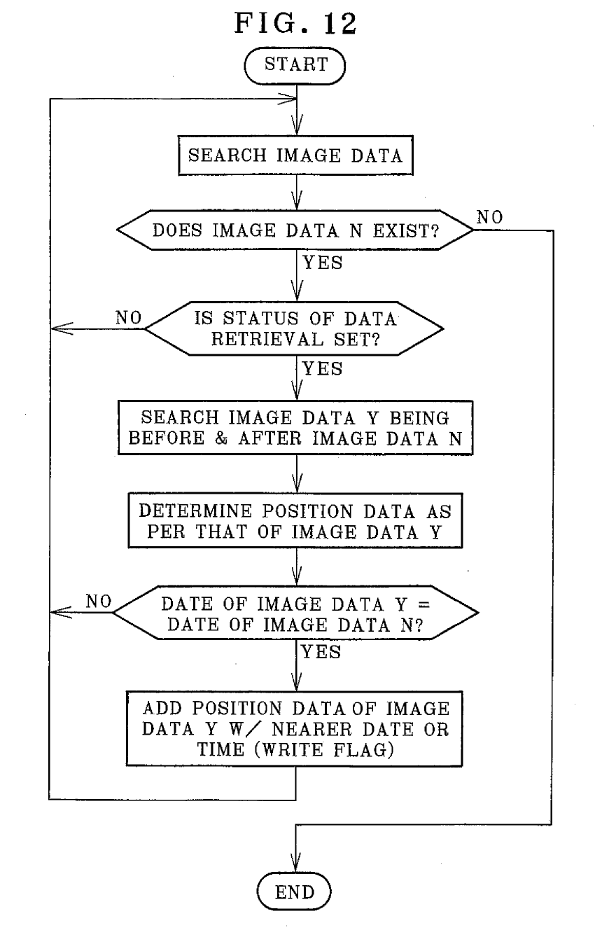

In FIG. 12, another preferred flow is illustrated. Position data for addition to the image data N can be calculated according to image data associated with image data Y after the image data Y is searched and found with a date or time near to that of the image data N.

To calculate the position data, points of the coordinates of the latitude and longitude of the position data of the second and third image data Y are used, the second and third image data Y being earlier and later than the first image data N. The points are connected graphically with a straight line, so as to calculate a latitude and longitude of a middle point of a segment of the straight line. Furthermore, a difference ΔT1 of a date or time between the second and third image data Y, and differences ΔT2 of a date or time between the first image data N and the second and third image data Y are calculated. A latitude and longitude is calculated according to a proportion of ΔT2 to ΔT1. For example, time of the second and third image data Y is 12 and 22 o'clock. Time of the first image data N is 16 o'clock. ΔT1=10 and ΔT2=4 and 6. Thus, a segment of the straight line passing the points of the latitude and longitude of the position data of the second and third image data Y is considered. A point of the latitude and longitude with a ratio of 4:6 in the segment of the straight line is derived, to obtain the position data. It is to be noted that other factors may be additionally considered, including a date or time of the second and third image data Y, a difference between the position data of the second and third image data Y (distance between positions).

If the date of the second image data Y is different from the date of the first image data N, then a rejection flag is generated and associated with the first image data N to return the routine, because the second image data Y is supposedly obtained by image pickup in a place different from that of the first image data Y. If the dates of the two image data are the same, the calculated position data is added as position data of the first image data N. This is effective in addition of position data for any of image data. In case of temporary disorder in the communication, influence of the failure can be suppressed between the camera and the telephone.

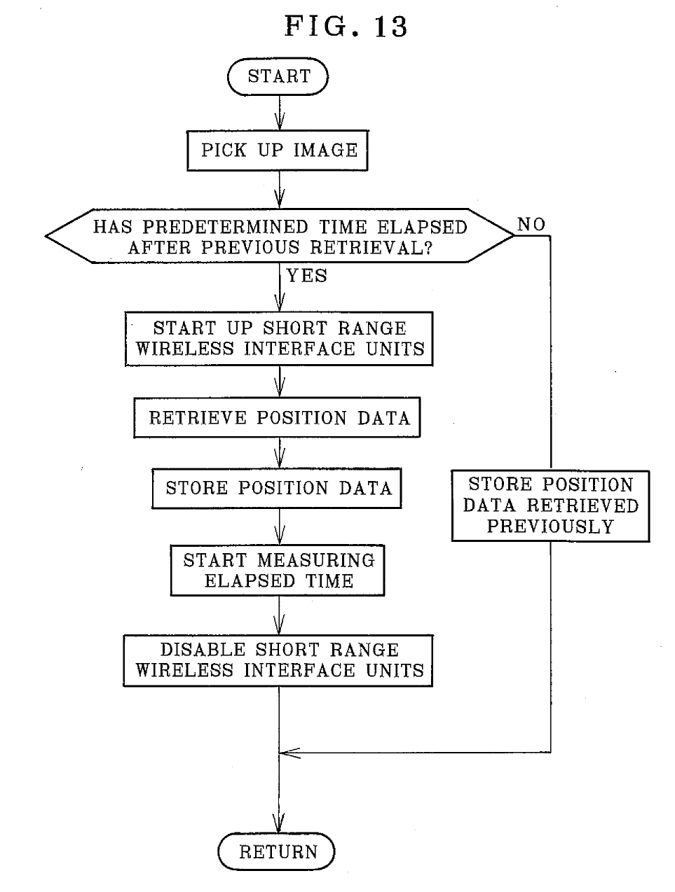

Furthermore, there are some situations where position data remains substantially unchanged for a limited time. Examples of the situations are a case of image pickup in one place for plural times, a case of image pickup in a small region where a user moves about on foot. In FIG. 13, another preferred embodiment is illustrated for such situations. Elapsed time after retrieval of the position data is measured according to the output of the clock circuit 30a (or specified timer). If the elapsed time is less than a threshold time (for example, 30 minutes), retrieval of position data is suppressed even when an image is picked up. The position data having been retrieved previously is recorded. Also, if the position data is retrieved, the short range wireless interface unit 46 is made inactive, and then started up when a predetermined time lapses. The measurement of the elapsed time is continued by powering the clock circuit 30a or a specified timer even when the power source of the camera is turned off. Accordingly, the use of the power can be slowed down in comparison with retrieval of position data at each time of image pickup.

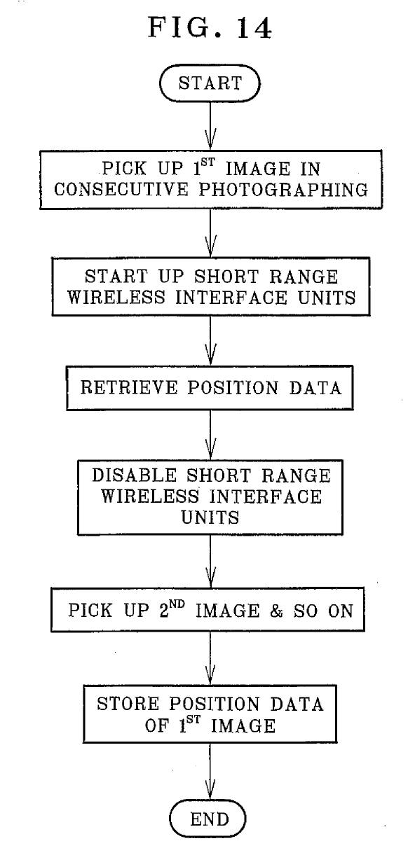

In FIG. 14, another preferred embodiment is illustrated for use in a consecutive photographing digital still camera. There is no change in the position data in consecutive image frames. Thus, position data is retrieved for a first image frame. However, no position data is retrieved for second and later image frames. The initially retrieved position data is recorded and stored for use. This embodiment is also effective in saving the power in a manner similar to that of FIG. 13.

In the above embodiment, the position data is transmitted from the cellular telephone 11 to the digital still camera 10. However, the invention is not limited to this structure. For example, a car navigation device can obtain position data in place of the cellular telephone 11, and transmit the position data to the digital still camera 10. Also, position data can be obtained by the digital still camera 10 and transmitted to the cellular telephone 11. Various examples of modification can be constructed according to the invention. Electronic devices can be various devices other than the digital still camera 10 and the cellular telephone 11. Information for transmission may be other than image data or position data. Other examples of communication may be constructed according to the invention in manners different from the above three embodiments.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An information communication system for transmitting data, comprising:
a main communication system for transmitting said data between plural electronic devices;
a communication subsystem for transmitting an enable signal between said plural electronic devices in response to operation to instruct retrieval of said data in an on-line status established constantly or intermittently between said plural electronic devices, said enable signal being transmitted while communication of said main communication system is in an off-line status;
a controller for establishing an on-line status of said main communication system by startup, and for establishing said off-line status of said main communication system to terminate communication after said data is transmitted through said main communication system.

2. An information communication system as defined in claim 1, wherein said electronic devices include:
a first electronic device for receiving said enable signal and outputting said data; and
a second electronic device for outputting said enable signal and receiving said data from said first electronic device.

3. An information communication system as defined in claim 2, wherein said communication subsystem is a wireless communication system.

4. An information communication system as defined in claim 3, wherein said first electronic device includes a data retriever for retrieving said data to be transmitted, and said second electronic device includes an image pickup unit for retrieving image data.

5. An information communication system as defined in claim 3, further comprising a timer for measuring first elapsed time elapsed after establishing communication of said main communication system;
said controller terminates communication of said main communication system when said first elapsed time becomes more than a predetermined first threshold value.

6. An information communication system as defined in claim 3, wherein said first electronic device includes a first interface unit and a first data communication unit;
said second electronic device includes a second interface unit and a second data communication unit;
said main communication system is constituted by said first and second data communication units, and said communication subsystem is constituted by said first and second interface units.

7. An information communication system as defined in claim 2, wherein said main communication system is a short range wireless communication system, said communication subsystem includes a public accessible wireless LAN network and a mobile communication network, said first electronic device is connectable with said mobile communication network, and said second electronic device is connectable with said public accessible wireless LAN network.

8. An information communication system as defined in claim 7, wherein said controller, when said second electronic device is on-line with said public accessible wireless LAN network, transmits said enable signal in said public accessible wireless LAN network, and immediately after transmission, sets said second electronic device off-line from said public accessible wireless LAN network for saving power.

9. An information communication system as defined in claim 3, wherein said second electronic device generates said enable signal upon shutter releasing of said image pickup unit.

10. An information communication system as defined in claim 3, wherein said communication subsystem includes a microphone for converting sound into said enable signal, and a speaker for converting said enable signal being received into sound.

11. An information communication system as defined in claim 10, wherein said sound is created upon shutter releasing of said image pickup unit.

12. An information communication system as defined in claim 3, wherein said enable signal is a sound signal on which enable signal data after OFDM modulation is multiplexed;
said communication subsystem includes:
a modulator for OFDM modulation of said enable signal data and for multiplexing said enable signal data on said sound signal;
a speaker for outputting said sound signal;
a microphone for detecting said sound signal; and
a demodulator for demodulating said enable signal data from said sound signal.

13. An information communication system as defined in claim 12, wherein said microphone operates intermittently, and said speaker outputs said sound signal in a longer period than a period of being inactive of said microphone.

14. An information communication system as defined in claim 4, wherein said data of transmission by said data retriever is present position data, and is obtained by access of a position data source.

15. An information communication system as defined in claim 14, wherein said data retriever is started up when said enable signal is transmitted in said communication subsystem, and made inactive after retrieval of said position data.

16. An information communication system as defined in claim 14, wherein said second electronic device includes a position data adder for operating in case of lack of position data with said image data, for reading second position data associated with second image data different from said image data, and for adding position data in association with said image data according to said second position data.

17. An information communication system as defined in claim 16, wherein said position data for addition is equal to said second position data, or is position data determined according to said second position data by said position data adder.

18. An information communication system as defined in claim 16, wherein if failure occurs in transmission of said enable signal in said communication subsystem upon retrieval of said image data, said position data adder suppresses addition of said position data.

19. An information communication system as defined in claim 16, wherein if a difference between a date or time of retrieval of said image data and a date or time of retrieval of said second image data is equal to or more than a predetermined threshold value, said position data adder suppresses addition of said position data.

20. An information communication system as defined in claim 16, wherein if a date of retrieval of said image data is before or after a date of retrieval of said second image data, said position data adder suppresses addition of said position data.

21. An information communication system as defined in claim 20, further comprising data storage for storing said image data and said position data associated therewith;
wherein when said position data adder adds said position data to said image data, status information is written to said data storage, said status information being associated with said image data for expressing a status of said addition.

22. An information communication system as defined in claim 20, further comprising a timer for measuring elapsed time elapsed after retrieval of said position data;
if said elapsed time is equal to or less than a predetermined threshold value, said communication subsystem suppresses communication of said enable signal.

23. An information communication system as defined in claim 20, wherein said image pickup unit is operable to pick up consecutive images;
said communication subsystem communicates with said enable signal for a first one of said consecutive images, and suppresses communication of said enable signal for second and succeeding images among said consecutive images.

24. An information communication method for transmitting data between plural electronic devices, comprising steps of:
transmitting an enable signal through a communication subsystem between said plural electronic devices in response to operation to instruct retrieval of said data, said enable signal being transmitted while communication of a main communication system is in an off-line status, and establishing an on-line status of said main communication system;
transmitting said data through said main communication system between said plural electronic devices; and
establishing said off-line status of said main communication system to terminate communication after said data is transmitted.
